(19) United States
(12) Patent Application Publication
(10) Pub. No.: US 2011/0295751 A1
(43) Pub. Date: Dec. 1, 2011

(54) System and method for subsidized internet access through preferred partners

(75) Inventors: Kotaro Matsuo, Poway, CA (US); David Sperling, Laguna Niguel, CA (US)

(73) Assignee: SMITH MICRO SOFTWARE, INC., ALISO VIEJO, CA (US)

(21) Appl. No.: 12/802,073

(22) Filed: May 27, 2010

(51) Int. Cl. G06Q 30/00; G06Q 10/00; G06Q 50/00; G06F 15/16

(52) U.S. Cl. 705/59; 709/203; 705/14.69; 705/14.45

(57) ABSTRACT

Provided are systems and methods for execution by a processor of a proxy server to provide a subsidized access to a network supported by a plurality of preferred partners. One method comprises receiving a first request from a client to access a first server on the network, forwarding the first request to a second server on the network such that the second server sends first content data over the network for rendering on a display of the client, recording the first request in a traffic log, and submitting the traffic log for reimbursement to at least one of the plurality of preferred partners affiliated with the second server to subsidize a cost of providing access to the network. By obtaining reimbursement for prioritizing and redirecting access to preferred sites, client connection costs can be fully or partially subsidized in light of additional revenue streams from increased user traffic.

### BACKGROUND OF THE INVENTION

1. Field of the Invention

The present invention relates generally to telecommunications. More particularly, the present invention relates to Internet access methods.

2. Background Art

The high cost of obtaining broadband service remains a high barrier to broadband adoption for a large majority of users. In the United States, broadband service must often be purchased as a long-term contract or is bundled as part of a television or telephone service package, increasing the total cost and commitment required from users. While mobile broadband over Wireless Wide Area Networks (“WWANs”) provide alternative access routes to the Internet, users are again generally forced to sign long-term contracts with a particular network provider. Since each network provider may service different portions of the wireless spectrum with proprietary networks and protocols, users are often locked into a single network and its associated hardware. Faced with these costs and limitations, many users may choose to forego broadband services entirely.

Business and companies with a commercial Internet presence therefore lose the opportunity to reach these users as potential customers. In particular, e-commerce sites, advertising networks, and other affiliated sites stand to lose a large amount of potential revenue from unreachable users. Due to the high costs of broadband Internet access, the reachable population of Internet users is thereby limited from its optimal levels.

While various methods of reduced cost Internet access are available, these methods still have many drawbacks. One example is free Wi-Fi offered at cafes, restaurants, and other establishments. While the Internet access is technically free, the implicit understanding is that the customer is purchasing food, drink, or other services for the use of the Wi-Fi service offered. Additionally, due to the limited range of Wi-Fi, the customer must stay within or in close proximity to the establishment, which is inconvenient for the user. Another example is employer subsidized Internet access, for example by using a company issued WWAN data card. To limit burdens and costs on company IT support staff, many employers may restrict access to only corporate local area networks or otherwise monitor and block access from non-work related Internet sites. As a result, employer provided Internet access may be too restrictive for general use.

Accordingly, there is a need to overcome the drawbacks and deficiencies in the art by providing a flexible and low cost method of accessing the Internet.

### SUMMARY OF THE INVENTION

There are provided systems and methods for subsidized Internet access through preferred partners, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for providing subsidized Internet access through preferred partners, according to one embodiment of the present invention;

FIG. 2 presents a diagram of a database table for providing subsidized Internet access through preferred partners, according to one embodiment of the present invention;

FIG. 3a presents a display of a web browser being redirected from a non-preferred provider to a preferred partner, according to one embodiment of the present invention;

FIG. 3b presents a display of a web browser having limited access to non-preferred providers, according to one embodiment of the present invention;

FIG. 3c presents a display of a web browser accessing a default interface with preferred partners in paid placement, according to one embodiment of the present invention; and

FIG. 4 shows a flowchart describing the steps, according to one embodiment of the present invention, by which subsidized Internet access through preferred partners may be provided.

### DETAILED DESCRIPTION OF THE INVENTION

The present application is directed to a system and method for subsidized Internet access through or supported by preferred partners. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

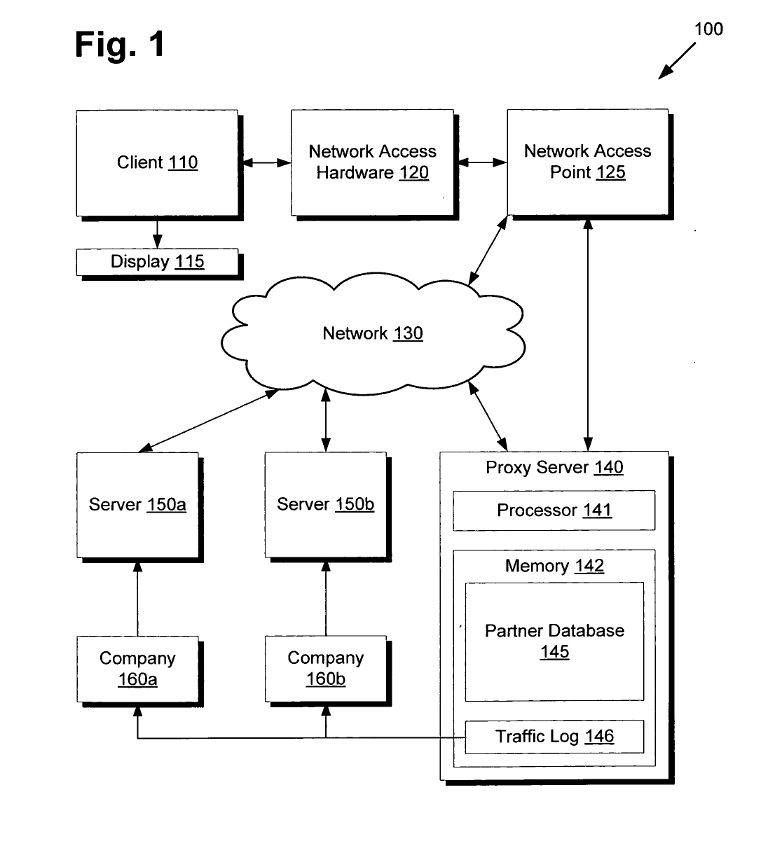

FIG. 1 presents a diagram of a system for providing subsidized Internet access through preferred partners, according to one embodiment of the present invention. System 100 of FIG. 1 includes client 110, display 115, network access hardware 120, network access point 125, network 130, proxy server 140, server 150a and 150b, and company 160a and 160b. Proxy server 140 includes processor 141 and memory 142. Memory 142 includes partner database 145 and traffic log 146.

Client 110 may comprise, for example, a desktop computer, a laptop computer, a tablet computer, a videogame console, a mobile phone, or any other device capable of accessing network 130 and outputting to display 115. Display 115 may, for example, comprise an integrated or external LCD display. Network 130 may, for example, comprise a public network such as the Internet.

To provide the user of client 110 with fully (free) or partially subsidized Internet access, some method of connecting to network 130 is required. Depending on business arrangements with network providers and the cost of the hardware, network access hardware 120 may be offered to the user of client 110 for free or a substantial discount. Network access hardware 120 may, for example, comprise a mobile broadband or WWAN data card, a DSL modem, a cable modem, or another device connectable to network access point 125. Network access point 125 may comprise, for example, a cellular tower for a wireless broadband provider or additional servers or equipment necessary for an Internet service provider. To minimize or eliminate setup costs and therefore provide a greater incentive for the user, wireless access methods may be preferable to wired access methods to avoid the cost outlays of laying out cables or fiber to the user.

Thus, client 110 can connect to network 130 using the provided network access hardware 120. However, client 110 is not provided unfettered access to network 130. All traffic from client 110 is first routed through a single point, or proxy server 140. For this routing to occur, servers operating at network access point 125 may for example redirect traffic to proxy server 140 if data packets indicate transmission using network access hardware 120, which may include an identifier to associate client 110 as a participant in the subsidized Internet program. Thus, normal pre-paid clients having network access hardware with a different identifier associated with pre-paid clients may be routed directly to network 130, allowing subsidized and pre-paid clients to coexist.

Proxy server 140 may be executing a traffic routing program on processor 141 to examine, modify, and route data packets originating from and destined to client 110 or other subsidized Internet clients. The traffic routing program may refer to partner database 145 to implement policies providing enhanced exposure or visibility of content from preferred partners while limiting or restricting access to content from other sources. Client activity may be recorded within traffic log 146 to be submitted instantaneously or periodically to preferred partner companies for reimbursement. Additionally, traffic log 146 may be formatted into a summary report that can be sent to non-participating companies to encourage participation in the subsidized Internet program by showing the amount of potential traffic being forfeited. While only a single proxy server 140 and a single client 110 is shown in FIG. 1, alternative embodiments may use multiple proxy servers for load balancing and to support a large number of clients.

To provide an example, server 150a might comprise a web server for a search engine hosted at “search-engine-1.com”, whereas server 150b might comprise a web server for a search engine hosted at “search-engine-2.com”. Company 160a may have negotiated with the owner of network access point 125 to participate in the subsidized Internet program, and thus server 150a of company 160a may be included as a preferred partner for the Internet search category within partner database 145. On the other hand, company 160b may have declined to participate in the subsidized Internet program and thus server 150b of company 160b may be indicated as a non-preferred site for the Internet search category in partner database 145.

When client 110 requests access to server 150a, or a search through “search-engine-1.com”, proxy server 140 may consult partner database 145 to confirm that a preferred partner owns server 150a. After such confirmation, proxy server 140 may simply pass the request through to network 130, allowing client 110 unfettered access to server 150a. However, when client 110 requests access to server 150b, or “search-engine-2.com”, proxy server 140 may consult partner database 145 to confirm that a non-participating company owns server 150b. As a result, proxy server 140 may modify the request to direct to the preferred partner in the same Internet search category, or search services provided by “search-engine-1.com” at server 150a. Proxy server 140 may alternatively allow the request to proceed to server 150b, but may impose certain limitations or restrictions. For example, access to non-preferred companies may be limited to a set amount of time per day or a number of times to access a particular site or may use slower or low priority network routes. Content provided to clients from non-preferred companies may have certain features disabled or blocked such as, for example, multimedia content, plug-in content, encrypted content, or non-web content such as instant messaging, FTP, or e-mail. Proxy server 140 may, for example, modify, discard, or substitute data packets destined for client 110 if originating from non-preferred sites.

After the access by client 110 is recorded in traffic log 146, the contents of traffic log 146 may be submitted instantaneously or periodically to company 160a for reimbursement. For example, company 160a may agree to pay a certain amount of money for each access from subsidized clients. This money can then go towards the costs of operating network access point 125 and proxy server 140, the costs of providing network access hardware 120 to client 110, and the costs of connecting to network 130. In this manner, although company 160a must subsidize the costs of connecting client 110 to network 130, company 160a may receive increased advertising revenues from client 110 to offset the subsidy. Similarly, a larger population of subsidized Internet users accessing network access point 125 may provide larger revenues offsetting the subsidy costs from reimbursements received from preferred partner companies such as company 160a. The user of client 110 attains free or low cost Internet access as a result. Thus, all parties involved may benefit from participation in the subsidized Internet program.

Moreover, as the program grows in popularity and a larger base of users is amassed, feedback reports derived from traffic log 146 may serve as an effective tool to persuade non-participating companies, such as company 160b, to join in the subsidy program. After a certain point, company 160b may determine that forfeiting Internet traffic originating from subsidized users is not in its best interests, and company 160b may also place a bid as a preferred partner for Internet search. Thus, as the subsidy program grows in popularity, more and more preferred providers may join, extending the portion of network 130 freely available to clients. This in turn makes the subsidized access more desirable for clients, providing a feedback loop encouraging user growth and increasing the value of the subsidy program for network carriers and business partners alike. Over time, the site preferences of users may be determined from analyzing traffic log 146, allowing the subsidy program to organize and target the most promising non-participating companies to join.

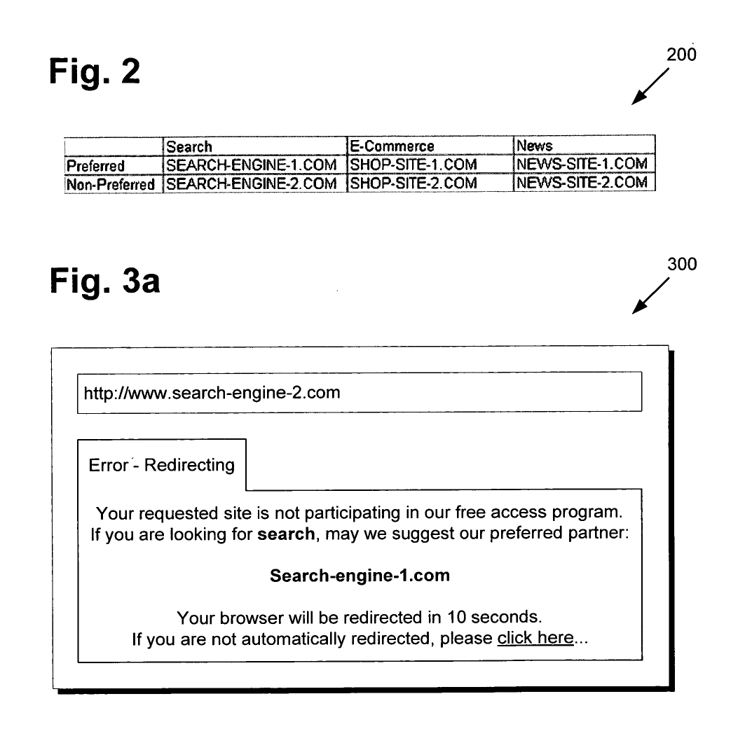

Moving to FIG. 2, FIG. 2 presents a diagram of a database table for providing subsidized Internet access through preferred partners, according to one embodiment of the present invention. Database table 200 of FIG. 2 may correspond to partner database 145 in FIG. 1.

As shown in database table 200, network servers are organized by content categories, or “Search”, “E-Commerce”, and “News”. Within these categories, network servers are indicated as either “Preferred” or “Non-Preferred”. Thus, “search-engine-1.com” is indicated as a preferred search provider, “shop-site-1.com” is indicated as a preferred E-commerce provider, and “news-site-1.com” is indicated as a preferred news provider. On the other hand, “search-engine-2.com” is indicated as a non-preferred search provider, “shop-site-2.com” is indicated as a non-preferred E-commerce provider, and “news-site-2.com” is indicated as a non-preferred news provider. While only a single preferred and non-preferred provider is included in each category for simplicity, alternative embodiments may include multiple preferred and non-preferred providers for each category, and some providers may be uncategorized or placed in a generic category. Moreover, while the distinction between “preferred” and “non-preferred” is indicated as a binary on or off condition for simplicity, alternative embodiments may provide for a numerical ranking system or another system allowing different degrees of preference for particular providers.

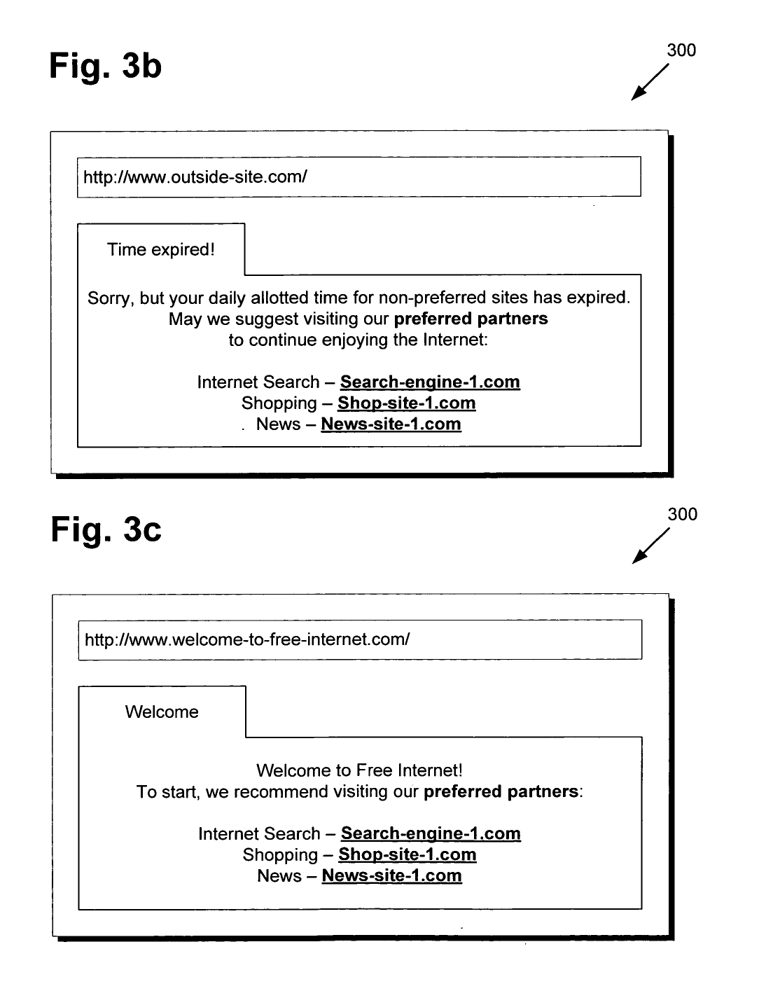

Moving to FIG. 3a, FIG. 3a presents a display of a web browser being redirected from a non-preferred provider to a preferred partner, according to one embodiment of the present invention. Display 300 of FIG. 3a may correspond to display 115 in FIG. 1.

As shown in FIG. 3a, the user may have typed in the URL for “search-engine-2.com” or alternatively selected “search-engine-2.com” as a bookmark or favorite. However, as indicated by database table 200 in FIG. 2, “search-engine-2.com” is a non-preferred search provider. Thus, the user may be presented with the interstitial redirection page shown in display 300 of FIG. 3a, informing the user that “search-engine-2.com” is not participating in the subsidy program and redirecting the user to the preferred search provider “search-engine-1.com” instead. Similarly, as indicated by database table 200 in FIG. 2, a user navigating to “shop-site-2.com” may be redirected to “shop-site-1.com”, and a user navigating to “news-site-2.com” may be redirected to “news-site-1.com”. As previously discussed, these redirections may be recorded in a traffic log and later presented to non-participating companies to encourage participation in the subsidy program. The redirection page may optionally include a “Click to recommend” button, allowing the user to directly recommend non-participating companies to participate in the subsidy program. Additionally, the redirection page may include an up-sell component, such as a “Click here for unrestricted access” button, allowing the subsidized customer to upgrade to a paying customer status using pre-pay or post-pay payment methods to obtain access to all sites regardless of provider.

Moving to FIG. 3b, FIG. 3b presents a display of a web browser having limited access to non-preferred providers, according to one embodiment of the present invention. Display 300 of FIG. 3b may correspond to display 115 in FIG. 1.

As shown in FIG. 3b, the user may have typed in the URL for “outside-site.com” or alternatively selected “outside-site.com” as a bookmark or favorite. However, as indicated by database table 200 in FIG. 2, “outside-site.com” is not listed as a preferred partner site. Thus, as previously discussed, proxy server 140 in FIG. 1 may allow only limited or restricted access to non-preferred sites such as “outside-site.com”. In the example shown in display 300 of FIG. 3b, a daily allotted time limit for non-preferred sites has expired or a number of times to access a particular site has expired, and the user is encouraged to instead freely visit preferred partner sites. As previously discussed, other limitations and restrictions may be enforced by proxy server 140 such as routing through slower network connections, or disabling or blocking multimedia content, plug-in content, non-web content, or encrypted content. As previously discussed in conjunction with FIG. 3a, a “Click to recommend” button may optionally be provided to allow the user to recommend that “outside-site.com” join the subsidy program. In addition, a “Click for full access” button might be provided to up-sell paid network access.

Moving to FIG. 3c, FIG. 3c presents a display of a web browser accessing a default interface with preferred partners in paid placement, according to one embodiment of the present invention. Display 300 of FIG. 3c may correspond to display 115 in FIG. 1.

Before allowing the user to access requested sites, a default startup page may be first shown to the user to provide enhanced visibility and exposure for preferred partners. Thus, for example, proxy server 140 may first determine whether an access from client 110 is the first in a given connection session, and if so, redirect the user to a default welcome page similar to that shown in display 300 of FIG. 3c. Thus, regardless of the initial request sent from client 110, a default startup page similar to that shown on display 300 of FIG. 3c may be shown on display 115. As shown in display 300 of FIG. 3c, the preferred partners contained in database 200 of FIG. 2 are prominently displayed for the user to click through. Besides at the beginning of a session, the default startup page might be occasionally inserted as an interstitial page. For example, the interstitial page may be periodically presented to the user with a gentle reminder message such as, “We hope you are enjoying Free Internet, generously supported by our preferred partners.” While the user is free to manually select another site, non-preferred sites may have access limitations enforced by proxy server 140, as previously described.

Since database table 200 in FIG. 2 may include numerical rankings specifying particular levels of preference, as previously described, these numerical rankings may be used to affect placement within the default startup page. Thus, for example, “search-engine-1.com” may comprise a level 1 preferred search partner, whereas “search-engine-3.com” might comprise a level 2 preferred search partner. Since “search-engine-1.com” has a higher preference than “search-engine-3.com”, only “search-engine-1.com” may show in the default welcome page of FIG. 3c. Alternatively, “search-engine-3.com” may be listed below “search-engine-1.com” or in less prominent typeface. Additionally, time based promotions may be supported, allowing dynamic repositioning of preferred partners within the default welcome page that may change from hour to hour or day to day. Thus, for example, high-traffic time slots might be sold for higher bids. As preferred partners can submit bids for preference levels and thus overall visibility, preferred partners can support the subsidy program as much or as little as desired with corresponding changes in content exposure and user access.

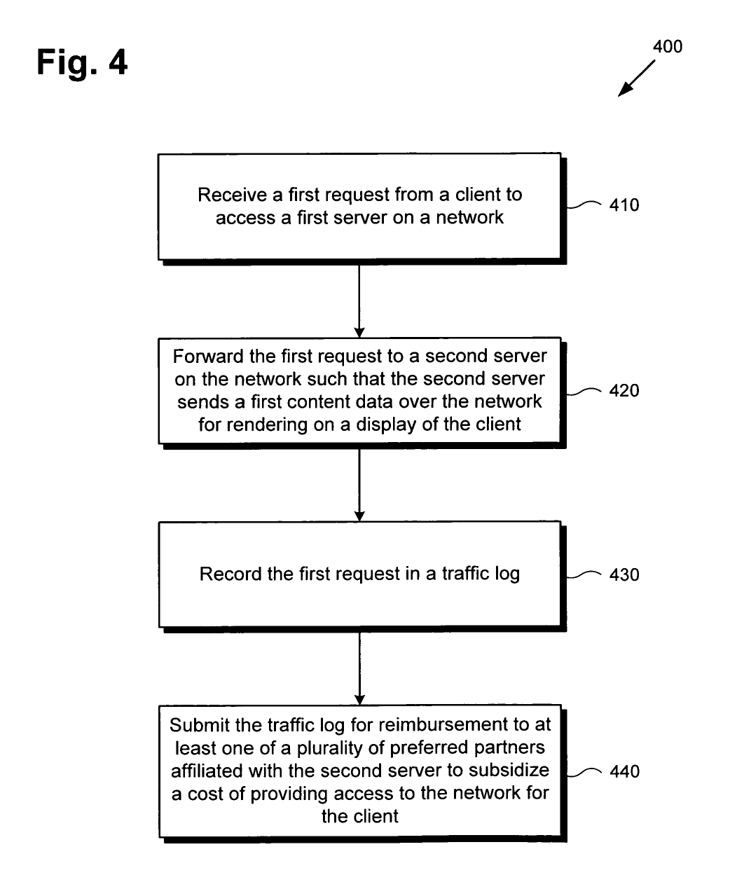

Moving to FIG. 4, FIG. 4 shows a flowchart describing the steps, according to one embodiment of the present invention, by which subsidized Internet access through preferred partners may be provided. Certain details and features have been left out of flowchart 400 that are apparent to a person of ordinary skill in the art. For example, a step may comprise one or more substeps or may involve specialized equipment or materials, as known in the art. While steps 410 through 440 indicated in flowchart 400 are sufficient to describe one embodiment of the present invention, other embodiments of the invention may utilize steps different from those shown in flowchart 400.

Referring to step 410 of flowchart 400 in FIG. 4 and system 100 of FIG. 1, step 410 of flowchart 400 comprises processor 141 of proxy server 140 receiving a first request from client 110 to access server 150b on network 130. Continuing with the example described above in conjunction with FIG. 1, server 150b may comprise a server for “search-engine-2.com”. Thus, the user of client 110 may have manually typed the URL or selected a bookmark or favorite for “search-engine-2.com” in a web browser. As previously described, client 110 may use network access hardware 120 to send the first request and subsequent requests via network access point 125, which may forward such requests to proxy server 140 instead of network 130 due to the presence of an identifier from network access hardware 120 indicating client 110 is participating in a subsidy program.

Referring to step 420 of flowchart 400 in FIG. 4 and system 100 of FIG. 1, step 420 of flowchart 400 comprises processor 141 of proxy server 140 forwarding the first request received from step 410 to server 150a such that server 150a sends a first content data over network 130 for rendering on display 115 of client 110. More specifically, since server 150b, or “search-engine-2.com”, may be indicated as a non-preferred site in partner database 145, proxy server 140 may decide to forward the first request to a preferred site, or server 150a hosting “search-engine-1.com”.

As previously described, if the first request comprises a preferred site already, then the first request may simply be passed through to the preferred site. Thus, if the first request directed instead to server 150a, then the request would simply be passed on directly to server 150a. In this case, step 420 would reduce to forwarding to the same original server, rather than redirecting to a different server.

After server 150a receives the request from proxy server 140, it may respond with the first content data, which may for example comprise HTML for a website. The first content data may then be sent directly back to client 110 over network 130 or forwarded to client 110 via proxy server 140. A web browser executing on client 110 may then render the first content data as a page visible on display 115.

While step 420 may redirect traffic from non-preferred sites to preferred sites, prior access to non-preferred sites, such as server 150b, may still be granted under certain limitations and restrictions. Thus, for example, prior to step 420, requests to server 150b may first be serviced within a limited time period or a number of times to access a particular site and/or with certain content restrictions or content blocking, as previously described. Once the limited time period or another condition expires, then proxy server 140 may begin to redirect accesses to non-preferred sites, as indicated in step 420.

Referring to step 430 of flowchart 400 in FIG. 4 and system 100 of FIG. 1, step 430 of flowchart 400 comprises processor 141 of proxy server 140 recording the first request received from step 410 in traffic log 146. As previously described, statistics gleaned from traffic log 146 may be used to direct further efforts to persuade additional preferred partners to join in the subsidy program.

Referring to step 440 of flowchart 400 in FIG. 4 and system 100 of FIG. 1, step 440 of flowchart 400 comprises processor 141 of proxy server 140 submitting traffic log 146 to company 160a affiliated with server 150a to subsidize a cost of providing access to network 130 for client 110. Thus, as previously described, company 160a may have an contractual arrangement with the owner of network access point 125 to pay a certain amount of money for each subsidized client access. Proxy server 140 may then submit these accesses recorded in traffic log 146 instantaneously or periodically to company 160a to claim reimbursement. The money may go towards costs of providing network access hardware 120, maintain network access point 125 and proxy server 140, and connections to network 130. Remaining money after costs provides a valuable stream of additional revenue for the owner of network access point 125.

As previously described, by demonstrating potential lost traffic in a feedback report, traffic log 146 may also be utilized to help persuade non-participating companies, such as company 160b, to join the subsidy program. As more companies join the subsidy program and provide free access to their content, the subsidized access provides greater value for users and thereby attracts more users, allowing a feedback loop to encourage growth of the subsidy program to provide increased revenues for network operators and Internet businesses while spreading free or low-cost Internet access for end users.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for execution by a processor of a proxy server to provide a subsidized access to a network supported by a plurality of preferred partners, the method comprising:
receiving a first request from a client to access a first server on the network;
forwarding the first request to a second server on the network such that the second server sends first content data over the network for rendering on a display of the client;
recording the first request in a traffic log; and
submitting the traffic log for reimbursement to at least one of the plurality of preferred partners affiliated with the second server to subsidize a cost of providing access to the network for the client.

2. The method of claim 1, wherein the first server and the second server are the same.

3. The method of claim 1 further comprising, prior to the forwarding:
determining that the first server is not affiliated with any of the plurality of preferred partners; and
selecting the second server such that a service category of the first server and a service category of the second server are the same.

4. The method of claim 3, wherein the service category comprises one of search, e-commerce, or news.

5. The method of claim 3, further comprising, after the recording:
generating a feedback report using the traffic log; and
sending the feedback report to a company affiliated with the first server to persuade the company to join the plurality of preferred providers.

6. The method of claim 3 further comprising, prior to the receiving:
passing, directly to the first server, a second request from the client to access the first server such that the first server sends a second data content over the network for rendering on the display of the client.

7. The method of claim 6, wherein the passing occurs only within a set period of time allocated for the client.

8. The method of claim 6 further comprising, after the passing:
modifying the second data content prior to the rendering on the display of the client to impose one or more access limitations.

9. The method of claim 8, wherein the one or more access limitations comprises disabling or blocking one of multimedia content, plug-in content, non-web content, or encrypted content.

10. The method of claim 1, wherein the network comprises the Internet.

11. A proxy server for providing subsidized access to a network supported by a plurality of preferred partners, the proxy server comprising:
a processor configured to:
receive a first request from a client to access a first server on the network;
forward the first request to a second server on the network such that the second server sends first content data over the network for rendering on a display of the client;
record the first request in a traffic log; and
submit the traffic log for reimbursement to at least one of the plurality of preferred partners affiliated with the second server to subsidize a cost of providing access to the network for the client.

12. The proxy server of claim 11, wherein the first server and the second server are the same.

13. The proxy server of claim 11 wherein prior to the forwarding the processor is further configured to:
determine that the first server is not affiliated with any of the plurality of preferred partners; and
select the second server such that a service category of the first server and a service category of the second server are the same.

14. The proxy server of claim 13, wherein the service category comprises one of search, e-commerce, or news.

15. The proxy server of claim 13 wherein after the recording the processor is further configured to:
generate a feedback report using the traffic log; and
send the feedback report to a company affiliated with the first server to persuade the company to join the plurality of preferred providers.

16. The proxy server of claim 13 wherein prior to the receiving the processor is further configured to:
pass, directly to the first server, a second request from the client to access the first server such that the first server sends a second data content over the network for rendering on the display of the client.

17. The proxy server of claim 16, wherein the processor is further configured to pass only within a set period of time allocated for the client.

18. The proxy server of claim 16 wherein after the passing the processor is further configured to:
modify the second data content prior to the rendering on the display of the client to impose one or more access limitations.

19. The proxy server of claim 18, wherein the one or more access limitations comprises disabling or blocking one of multimedia content, plug-in content, non-web content, or encrypted content.

20. The proxy server of claim 11, wherein the network comprises the Internet.
